(19) United States
(12) Patent Application Publication
(10) Pub. No.: US 2003/0182172 A1
(43) Pub. Date: Sep. 25, 2003

(54) System and method to build project management processes

(76) Inventors: Stuart Lee Claggett, Springfield, VA (US); Hyung Lee, Clifton, VA (US); Guerry Lim, Centreville, VA (US)

Correspondence Address: MCGUIRE WOODS LLP, 1750 TYSONS BOULEVARD, SUITE 1800, MCLEAN, VA, 22102, US

(21) Appl. No.: 10/103,784

(22) Filed: Mar. 25, 2002

(51) Int. Cl. G06F 17/60

(52) U.S. Cl. 705/9

(57) ABSTRACT

In a system and method to build a project management process, standard project management tools are used to design traditional project management tasks. These tasks are converted and mapped to workflow process definitions. The repetitive activities may be predefined in the workflow and mapped appropriately to the tasks as one or more predefined process definitions, each of which may be composed of other predefined process definitions. The resulting workflow process definitions are adapted to form the project management process suitable to be executed in a workflow engine.

### FIELD OF THE INVENTION

This invention relates generally to project management. More specifically, this invention relates to building project management processes.

### BACKGROUND OF THE INVENTION

There are many challenges associated with bringing products into a market place. For instance, the designers, engineers, and/or managers are under ever-present pressure to cut costs, increase quality, and meet schedules of deliveries. As a result, many enterprises are realizing that efficient execution of project management processes is critical to the success of the enterprise. Project management process is typically composed of a set of work activities that are executed to accomplish one or more goals. An example of project management processes is a business process such as product development, equipment purchasing, technical support, IT project implementation, and the like.

Project management tools are typically used to create and manage project management processes. One example of a project management tool is MICROSOFT PROJECT. Most conventional project management tools generate a Gantt-chart, which graphically represents a project as a schedule of tasks over a time line. Each task is represented as a bar having a length proportional to the duration for the completion of the task.

One of the short-comings of the Gantt-chart is that it does not provide visibility into the work and products of the actual project. In other words, simply viewing a Gantt-chart does not allow a project manager to determine the true status of the work associated with various tasks and the persons responsible for each task, amount of time and money spent on a particular task, and the like. Thus the project manager typically supplements conventional project management tools with “to do lists” and/or using other separate management tools. The supplemental management tools do not provide automatic structure and/or logic to the project, and hence requires substantial manual intervention.

Despite the proliferation and use of various project management tools, the project manager may still be without a complete picture for a project. To compensate, the project manager often inserts numerous additional tasks and repeats them throughout a project schedule. For example, a QA review and approval set of processes for many tasks and activities are the same. Another example of processes with repetitive tasks is purchasing. In a project, multiple products may need to be purchased such as computer equipment, software, and the like. The tasks to be performed for the purchase of each product may be repeated with the only difference being the particular product purchased. Repetitive tasks help to record the detailed minute activities that should be performed to accomplish the project.

However, inserting multiple repetitive tasks increases the complexity, but still does not provide the project manager with the capability to determine the status of a task within the project or the project itself. The project manager may directly query the persons involved to receive status information, but even in this instance, the related information or work reported back is often insufficient. These inefficiencies may increase the cost of the project, cause schedules to overrun, reduce the chances of the status information being accurate and reduce the quality of the project output.

### SUMMARY OF THE INVENTION

An embodiment of the present invention is a method to build a project management process. The method includes loading one or more tasks related to the project management process into a project management data repository. The method also includes converting the one or more tasks from the project management data repository to one or more process definitions, wherein the one or more process definitions includes at least one of a predefined process definition and a project-specific process definition. The method further includes adapting the one or more process definitions to form the project management process suitable for a workflow engine.

Another embodiment of the present invention is a system capable of building a project management process. The system includes a project management data module configured to load one or more tasks related to the project management process into a project management data repository. The system also includes a process definition module configured to convert the one or more tasks from the project management data repository to one or more process definitions, wherein the one or more process definitions includes at least one of a predefined process definition and a project-specific process definition. The system further includes a workflow generation module configured to adapt the one or more process definitions to form the project management process suitable for a workflow engine.

A further embodiment of the present invention is a system capable of building a project management process. The system includes means for loading one or more tasks related to the project management process into a project management data repository. The system also includes means for converting the one or more tasks from the project management data repository to one or more process definitions, wherein the one or more process definitions includes at least one of a predefined process definition and a project-specific process definition. The system further includes means for adapting the one or more process definitions to form the project management process suitable for a workflow engine.

Yet another embodiment of the present invention is computer readable storage medium on which is embedded one or more computer programs wherin the one or more computer programs containing a set of instructions to implement a method to build a project management process. The implemented method includes a step of loading one or more tasks related to the project management process into a project management data repository. The implemented method also includes a step of converting the one or more tasks from the project management data repository to one or more process definitions, wherein the one or more process definitions includes at least one of a predefined process definition and a project-specific process definition. The implemented method further includes a step of adapting the one or more process definitions to form the project management process suitable for a workflow engine.

### BRIEF DESCRIPTION OF THE DRAWINGS

Various features of the present invention can be more fully appreciated as the same become better understood with reference to the following detailed description of the present invention when considered in connection with the accompanying figures, in which:

FIG. 1 illustrates an exemplary system where an embodiment of the present invention may be practiced;

FIG. 2 illustrates an exemplary flow diagram according to an embodiment of the invention;

FIG. 3 illustrates an exemplary architecture of the process definition module illustrated in FIG. 1;

FIG. 4 illustrates an exemplary flow diagram detailing the converting step illustrated in FIG. 2; and

FIG. 5 illustrates an exemplary computer system where an embodiment of the present invention may be practiced.

### DETAILED DESCRIPTION

For simplicity and illustrative purposes, the principles of the present invention are described by referring mainly to exemplary embodiments thereof. However, it should be understood that the same principles are equally applicable to, and can be implemented in, all types of project management processes, and that any such variations do not depart from the true spirit and scope of the present invention.

Moreover, in the following detailed description, references are made to the accompanying drawings, which illustrate specific embodiments in which the present invention may be practiced. Electrical, mechanical, logical and structural changes may be made to the embodiments without departing from the spirit and scope of the present invention. The following detailed description is, therefore, not to be taken in a limiting sense and the scope of the present invention is defined by the appended claims and their equivalents.

According to an embodiment of the present invention, a workflow generation module is utilized to build a project management process. The workflow generation module may be adapted to receive information associated with a project and adapted to receive process definitions. The process definitions may include project-specific and/or predefined process definitions. Each process definition may determine a set of activities that need to be performed to complete one or more associated tasks.

Accordingly, the workflow generation module may be configured to integrate the process definitions to form a project management process. Subsequently, the project management process may be utilized by a workflow engine. In this manner, project tasks are brought into the workflow, and thus the activities related to each task may be monitored, audited, archived, and processed using standard workflow methodologies. The workflow engine may also be used to leverage an enterprise's expertise in existing processes. Such capability allows a project manager to define a traditional work project plan and allow the project workflow process to manage and track the work activities that can be performed by a human user or system/device.

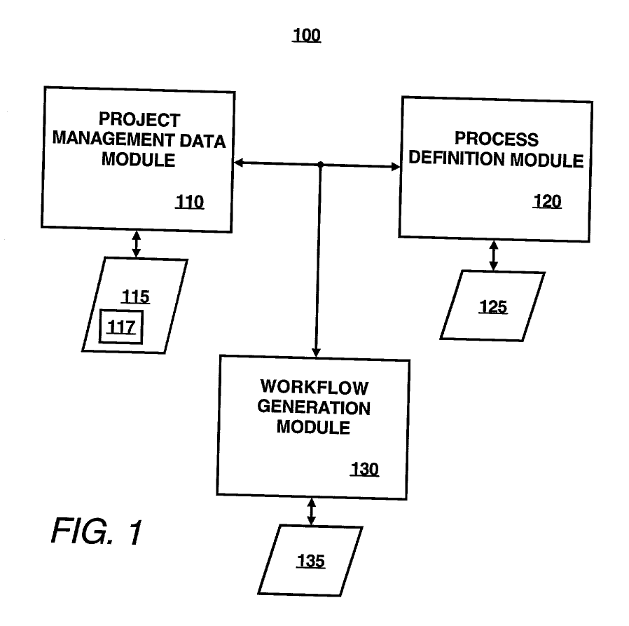

FIG. 1 illustrates an exemplary system 100 according to an embodiment of the present invention. As shown, the system 100 includes a project management data module 110 configured to load one or more tasks related to the project management process into a project management data repository 115. One or more attributes 117 may be associated with any of the tasks in the project management data repository. Some of the attributes 117 may be simply flag values. The project management data repository 115 may be maintained as a data file, a text file, a database, or combinations thereof.

The system 100 also includes a process definition module 120 configured to convert each task from the project management data repository to one or more process definitions. The process definitions may be stored in a process definition data repository 125, which may be a data file, text file, a database, or any combination thereof. The process definition module 120 is described in further detail below.

The system 100 also includes a workflow generation module 130 configured to adapt the process definition(s) generated by the process definition module 120 to form the project management process suitable for a workflow engine. The project management process may be stored in the workflow data repository 135, which again may be a data file, text file, a database, or any combination thereof.

The project management process formed from the workflow generation module 130 may be then executed in a workflow engine. In this manner, all tasks of the project management process may be tied and tracked to actual work activities. The work associated with the tasks such as documents, approvals, reviews, attachments, collaboration, and the like may be collected and organized for a complete project archive including an audit trail. The use of the workflow engine provides the project manager abilities to monitor the true work activities and modify the work activities in real time in an automated fashion and provides for a full audit trail of activities.

In addition, work performed by non-project team members may also be included for total project accountability. For example, the project management process may call for an equipment purchase. The purchasing activity may call for approval from a different department of the enterprise or may depend on an outside vendor's performance. These types of activities may also be tracked through the workflow methodologies.

Regarding the task(s) loaded by the project management data module 110, standard project management tools may be used to define the task(s) related to the project management process. Examples of standard project management tools include the MICROSOFT PROJECT and SCITOR'S PROJECT SCHEDULER. It should be understood from the foregoing discussion that any database that collects project task information may be utilized.

Also, the project management data module 110 may be configured to designate one or more attributes of the task(s) that determines the way in which each task is to be initiated. Further, the project management data module 110 may be configured to designate an additional attribute to signify whether or not a task is to be associated with one or more predefined processes.

The predefined process may include the existing activities known to an enterprise, and thus need not be described in detail within the project management tool. In this manner, the project management tool may be used to record major milestones and other important aspects without the clutter of repetitive tasks obscuring the view of the important tasks.

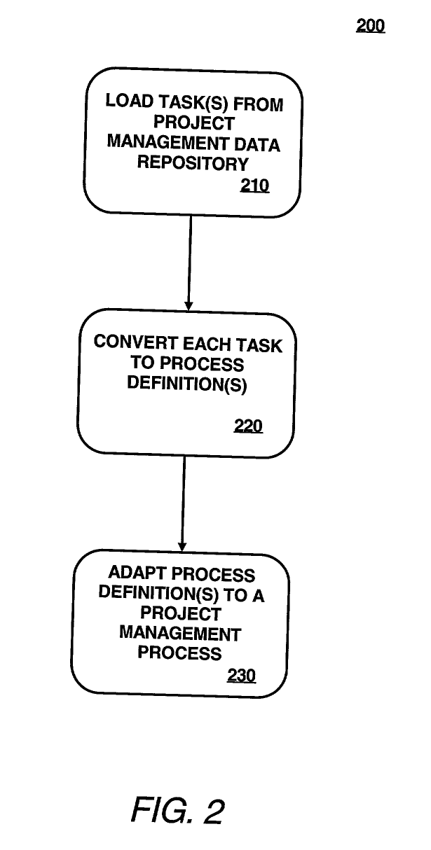

FIG. 2 illustrates a flow diagram of an exemplary method 200, performed by the exemplary system 100, to build a project management process according to an embodiment of the present invention. As shown, the method 200 includes step 210, typically performed by the project management data module 110, of loading the task(s) related to the project management process into the project management data repository 115. As noted above, the project management data repository 115 may be stored as a data file, a text file, in a database, or any combination thereof. Also as noted previously, standard project management tool may be used to define the task(s) related to the project management process.

The method 200 also includes step 220, typically performed by the process definition module 120, of converting each task from the project management data repository 115 to one or more process definitions. Each process definition may be project-specific or predefined. The converted process definitions may be stored in the process definition data repository 125, which may be a data file, a text file, a database, or any combination thereof. The details of step 220 is further described below.

The method 200 includes further includes step 230, typically performed by the workflow generation module 130, of adapting the converted process definition(s) to form the project management process suitable for a workflow engine. The formed project management project process may be stored in the workflow data repository 135, which may be a data file, a text file, a database, or any combination thereof.

It is worth noting again that the formed project management process may be executed in a workflow engine, which allows for the tasks of the project management process to be tied and tracked to actual work activities.

Referring back to step 210 of loading task(s) from the project management data repository 115, the project management module 110 may designate one or more attributes of the task(s) that determines the way in which each task is to be initiated and/or processed. Further, the project management data module 110 may designate other attribute(s) of the task(s) to signify whether or not a task is associated with one or more predefined processes.

Also in step 210, each task may be designated to be associated with one or more predefined processes. It is worth noting again that as a result, the project management tool may be used to record milestones and other important aspects without the clutter of repetitive tasks obscuring the view.

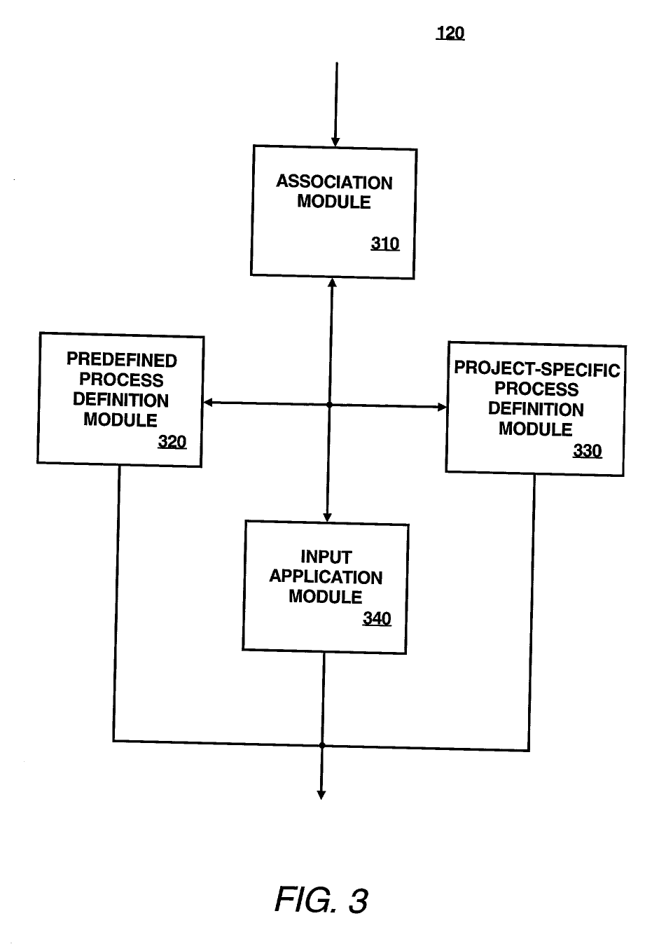

FIG. 3 illustrates an exemplary architecture of the process definition module 120 illustrated in FIG. 1. As shown in FIG. 3, the exemplary process definition module 120 includes an association module 310 configured to determine if one or more predefined process definitions are associated with any tasks. The association module 310 may, for example, simply utilize a flag value within an attribute 117 (see FIG. 1) for the particular task to make the determination.

If the association module 310 determines that the particular task does have an association with one or more predefined process definitions, then the association module 310 may communicate with a predefined process definition module 320. The predefined process definition module 320 maps the task with the associated predefined process definition(s). The predefined process definitions may be stored in the process definition data repository 125.

It is also possible that a particular predefined process definition may be recursively defined. That is, one predefined process definition may be composed of other predefined process definition(s). The other predefined process definition(s) may be composed of yet another predefined process definition(s) and so on. Thus, the association module 310 and the predefined process definition module 320 may be configured to recursively determine and map the sublevels predefined process definitions with the particular task if the determination warrants.

This capability allows enterprises to hierarchically organize and leverage their existing processes and to build additional processes as new expertise is developed. For example, as previously noted, purchase and quality assurance (“QA”) processes may exist as formal processes in an organization. An enterprise may develop a new process using a combination of the purchase and QA processes.

On the other hand, if the association module 310 determines that a particular task is not associated with a predefined process definition, the association module 310 communicates with the project-specific process definition module 330. The project-specific process definition module 330 generates a project-specific process definition and maps the task with the project-specific process definition.

A structure of the project-specific process definition may be based on user preferences or may be defaulted to a pre-determined structure. The structure of the process definition, whether project-specific or predefined, may include participants, roles and permissions of the participants, directory structure, placement of data, and any other similar associated information. It should be understood from the foregoing discussion that fields of the process definition structure may be added, modified, and/or deleted.

The process definition module 120 may further include an input application module 340 configured to select one or more input applications for a process definition that requires inputs. It may be that one or more process definitions require inputs from an external source of data. For example, when processing an insurance claim, information of the claimant is required and -maybe entered, for example, through a predetermined form that interacts with the appropriate input application. Other types of input applications may include materials availability, competitive vendor pricing and the like.

Input applications may be predefined as well, and may be used to send partial or 100% completion notifications to update the workflow database (not shown) during execution of the project management process in a workflow engine. The input application may be adapted to add, modify, and/or delete data in the workflow database.

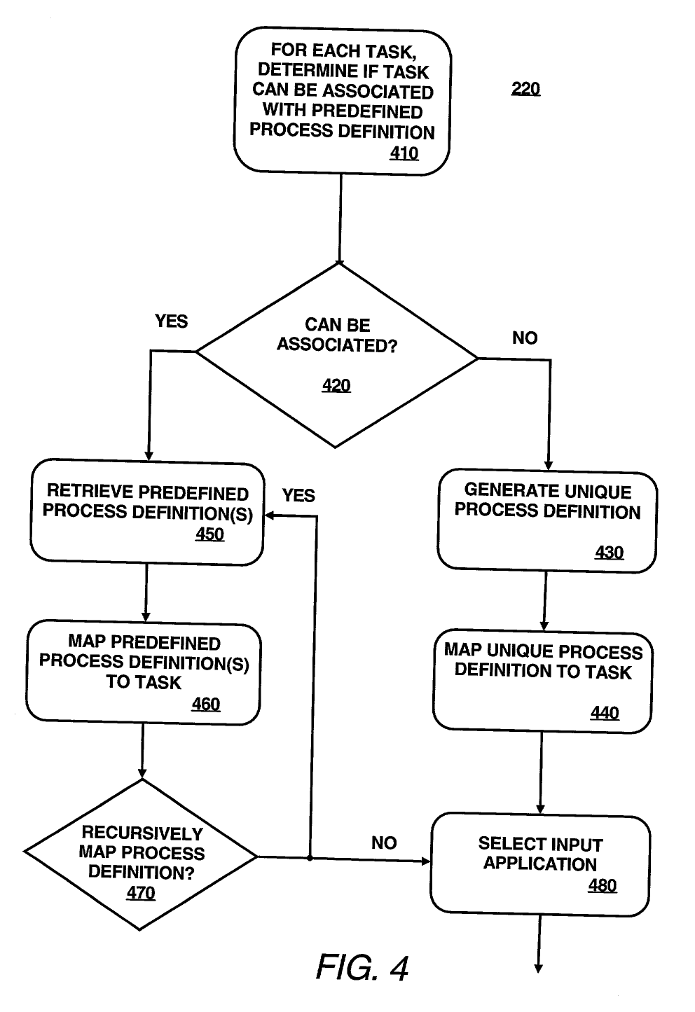

FIG. 4 illustrates an exemplary flow diagram detailing the converting step 220 illustrated in FIG. 2. The converting step 220 exemplified in FIG. 4 is performed for each task related to the project management process. As shown in FIG. 4, the converting step 220 includes the sub-steps 410 and 420, typically performed by the association module 310, to determine if a task is associated with one or more predefined process definitions. If the association module 310 determines that a particular task may be associated, the associated predefined process definition(s) are retrieved (step 450) and mapped to the particular task (step 460), typically by the predefined process definition module 320.

As noted above, the predefined process definitions may be composed of other predefined process definitions and so on. Thus at step 470, if it is determined that recursive mapping is needed, then the association module 310 and the predefined process definition module 320 cooperate to recursively map the predefine process definitions as necessary. Otherwise, input applications may be selected for the predefined definitions (step 480).

On the other hand, if the association module 310 determines that a particular task is not associated with any predefined process definitions, then the project-specific process definition module 330 generates a project-specific process definition (step 430) and maps the project-specific process definition to the particular task (step 440). As noted above, the structure of the project-specific process definition may be based on user preferences or may be defaulted to a particular structure. Again, one or more input applications may be selected by the input application module 340 for each process definition requiring inputs (step 480).

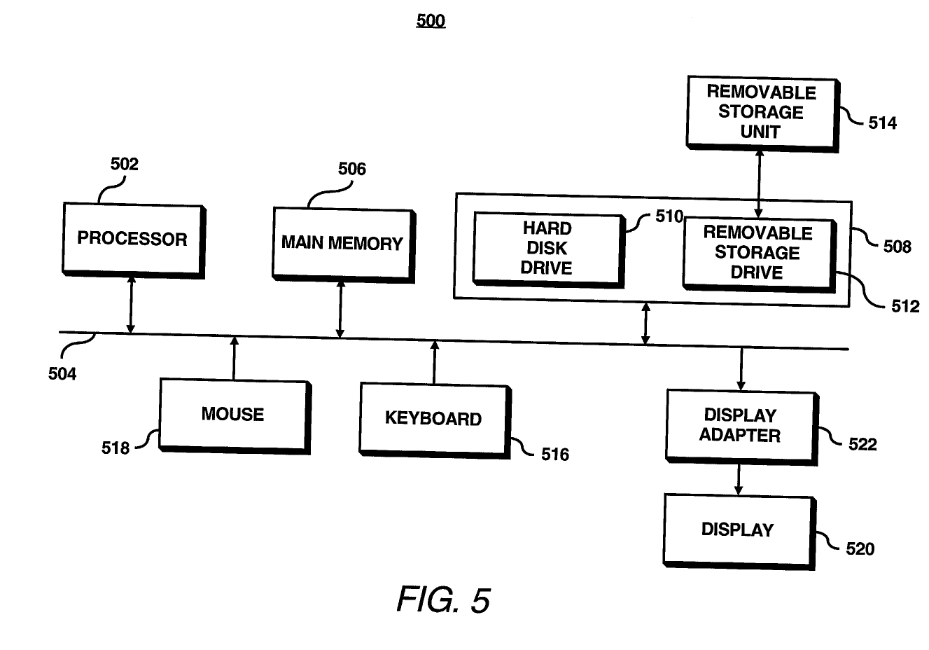

FIG. 5 illustrates an exemplary block diagram of a computer system 500 where an embodiment of the present invention may be practiced. The functions of the system 100, i.e. the project management data module 110, the process definition module 120, and the workflow generation module 130, may be implemented in program code and executed by the computer system 500. The program code may be written in computer languages such as PASCAL, C, C++, JAVA, and the like.

As shown in FIG. 5, the computer system 500 includes one or more processors, such as processor 502, that provides an execution platform. Commands and data from the processor 502 are communicated over a communication bus 504. The computer system 500 also includes a main memory 506, preferably Random Access Memory (RAM), where the software for the system 100 may be executed during runtime, and a secondary memory 508. The secondary memory 508 includes, for example, a hard disk drive 510 and/or a removable storage drive 512, representing a floppy diskette drive, a magnetic tape drive, a compact disk drive, and the like, where a copy of a computer program embodiment for the system 100 may be stored. The removable storage drive 512 reads from and/or writes to a removable storage unit 514 in a well-known manner. A user interfaces with the system 100 with a keyboard 516, a mouse 518, and a display 520. The display adaptor 522 interfaces with the communication bus 504 and the display 520 and receives display data from the processor 502 and converts the display data into display commands for the display 520.

Certain embodiments of the present invention may be performed as a computer program. The computer program may exist in a variety of forms both active and inactive. For example, the computer program can exist as software program(s) comprised of program instructions in source code, object code, executable code or other formats; firmware program(s); or hardware description language (HDL) files. Any of the above can be embodied on a computer readable medium, which include storage devices and signals, in compressed or uncompressed form. Exemplary computer readable storage devices include conventional computer system RAM (random access memory), ROM (read-only memory), EPROM (erasable, programmable ROM), EEPROM (electrically erasable, programmable ROM), and magnetic or optical disks or tapes. Exemplary computer readable signals, whether modulated using a carrier or not, are signals that a computer system hosting or running the present invention can be configured to access, including signals downloaded through the Internet or other networks. Concrete examples of the foregoing include distribution of executable software program(s) of the computer program on a CD-ROM or via Internet download. In a sense, the Internet itself, as an abstract entity, is a computer readable medium. The same is true of computer networks in general.

While the invention has been described with reference to the exemplary embodiments thereof, those skilled in the art will be able to make various modifications to the described embodiments of the invention without departing from the true spirit and scope of the invention. The terms and descriptions used herein are set forth by way of illustration only and are not meant as limitations. In particular, although the method of the present invention has been described by examples, the steps of the method may be performed in a different order than illustrated or simultaneously. Those skilled in the art will recognize that these and other variations are possible within the spirit and scope of the invention as defined in the following claims and their equivalents.

What is claimed is:

1. A method to build a project management process, comprising:
loading one or more tasks related to the project management process into a project management data repository;
converting the one or more tasks from the project management data repository to one or more process definitions, wherein the one or more process definitions includes at least one of a predefined process definition and a project-specific process definition; and
adapting the one or more process definitions to form the project management process suitable for a workflow engine.

2. The method of claim 1, wherein the converting step comprises:
determining if the one or more predefined process definition is associated for each of the one or more tasks;
mapping the one or more predefined process definitions for a task determined to be associated in the determining step; and
generating and mapping the project-specific process definition for a task determined not to be associated in the determining step.

3. The method of claim 2, wherein the converting step further comprises:
determining if any of the one or more associated predefined process definitions are composed of one or more other predefined process definitions; and
recursively mapping the one or more other predefined process definitions to the task determined to be associated in the determining step in response to the determining step making a positive determination.

4. The method of claim 3, further comprising:
maintaining a list of predefined process definitions in a process definition repository.

5. The method of claim 2, wherein the determining step utilizes a flag attribute of the one or more tasks to determine if the one or more predefined process definitions should be associated with the one or more tasks.

6. The method of claim 2, wherein the converting step further comprises:
selecting one or more input applications for each of the one or more process definitions requiring inputs.

7. The method of claim 6, wherein the one or more input applications are adapted to add, modify, or delete one or more data fields in a workflow database during execution of the workflow engine.

8. The method of claim 1, wherein the loading step comprises:
designating a way in which the one or more tasks are to be initiated in the workflow engine; and
designating whether or not the one or more tasks is to be associated with one or more predefined processes.

9. A system capable of building a project management process, comprising:
a project management data module configured to load one or more tasks related to the project management process into a project management data repository;
a process definition module configured to convert the one or more tasks from the project management data repository to one or more process definitions, wherein the one or more process definitions includes at least one of a predefined process definition and a project-specific process definition; and
a workflow generation module configured to adapt the one or more process definitions to form the project management process suitable for a workflow engine.

10. The system of claim 9, wherein the process definition module comprises:
an association module configured to determine if the one or more predefined process definitions are associated for the one or more tasks; and
a predefined process definition module configured to map the one or more tasks to the one or more predetermined process definitions based on a positive determination from the association module.

11. The system of claim 10, wherein the process definition module further comprises a project-specific process definition module configured to generate and map the project-specific process definition to the one or more tasks based on a negative determination from the association module.

12. The system of claim 10, wherein:
the association module is further configured to recursively determine if any of the one or more associated predefined process definitions are composed of one or more other predefined process definitions; and
the predefined process definition module is further configured to recursively map the one or more other predefined process definitions to the task determined to be associated in the determining step based on a positive determination from the association module.

13. The system of claim 12, wherein the process definition data repository includes one or more of a data file, a text file, and a database.

14. The system of claim 10, wherein the association module is configured to utilize a flag attribute of the one or more tasks to determine if the one or more predefined process definitions should be associated with the one or more tasks.

15. The system of claim 10, wherein the process definition module further comprises an input application module configured to select one or more input applications for each of the one or more process definitions.

16. The system of claim 15, wherein the one or more input application is adapted to add, modify, or delete one or more data fields in a workflow database during execution of the workflow engine.

17. The system of claim 9, wherein the project management data module is further configured to designate a first attribute that determines the way in which the one or more tasks is to be initiated and to designate a second attribute to signify whether or not the one or more tasks is to be associated with one or more predefined process.

18. The system of claim 9, wherein the project management data repository includes one or more of a data file, text file, and a database.

19. A system capable of building a project management process, comprising:
means for loading one or more tasks related to the project management process into a project management data repository;
means for converting the one or more tasks from the project management data repository to one or more process definitions, wherein the one or more process definitions includes at least one of a predefined process definition and a project-specific process definition; and
means for adapting the one or more process definitions to form the project management process suitable for a workflow engine.

20. The system of claim 19, wherein the means for converting comprises:
means for determining if one or more predefined process definitions are associated for the one or more tasks; and
means for mapping the one or more tasks to the one or more predetermined process definitions based on a positive determination from the means for determining.

21. The system of claim 20, wherein the means for converting further comprises:
means for mapping the one or more predefined process definitions to the one or more tasks based on a positive determination from the means for determining;
means for generating a project-specific process definition and map the project-specific process definition to the one or more tasks based on a negative determination from the means for determining.

22. The system of claim 21, wherein:
means for determining if any of the one or more associated predefined process definitions are composed of one or more other predefined process definitions; and
means for recursively mapping the one or more other predefined process definitions to the task determined to be associated based on a positive determination from the means for determining.

23. A computer readable storage medium on which is embedded one or more computer programs, the one or more computer programs containing a set of instructions to implement a method to build a project management process, the method comprising the steps of:
loading one or more tasks related to the project management process into a project management data repository;
converting the one or more tasks from the project management data repository to one or more process definitions, wherein the one or more process definitions includes at least one of a predefined process definition and a project-specific process definition; and
adapting the one or more process definitions to form the project management process suitable for a workflow engine.

24. The computer readable storage medium of claim 23, wherein the converting step comprises:
determining if one or more predefined process definition is associated for each of the one or more tasks;
mapping the one or more predefined process definition for a task determined to be associated in the determining step; and
mapping a project-specific process definition for a task determined not to be associated in the determining step.

25. The computer readable storage medium of claim 24, wherein the converting step further comprises:
determining if any of the one or more associated predefined process definitions are composed of one or more other predefined process definitions; and
recursively mapping the one or more other predefined process definitions to the task determined to be associated in the determining step in response to the determining step making a positive determination.
